(19) United States
(12) Patent Application Publication
(10) Pub. No.: US 2011/0047569 A1
(43) Pub. Date: Feb. 24, 2011

(54) SYSTEM AND METHOD OF PROVIDING IMPROVED RECEPTION OF BROADCAST SIGNALS

(75) Inventors: Mark Gilmore Mears, Zionsville, IN (US); Michael Crabb, Carmel, IN (US)

Correspondence Address: FLETCHER YODER P.C., 7915 FM 1960 RD. WEST, SUITE 330, HOUSTON, TX, 77070, US

(73) Assignee: Shenzhen TCL New Technology LTD, Shenzhen (CN)

(21) Appl. No.: 12/674,792

(22) PCT Filed: Sep. 28, 2007
(86) PCT No.: PCT/US07/79934

§ 371 Date: Feb. 23, 2010

(30) Foreign Application Priority Data
Sep. 13, 2007 (CN) 200710077095.7

(51) Int. Cl. H04N 5/445; H04N 5/44

(52) U.S. Cl. 725/39; 725/38; 348/731; 348/E05.096

(57) ABSTRACT

A method comprises playing a selected channel. The method further comprises determining a quality metric for the selected channel, determining whether an alternate channel with the same program as the selected channel is available, determining a quality metric for the alternate channel if the alternate channel with the same program as the selected channel is available, and playing the alternate channel if the quality metric of the alternate channel is higher than the quality metric of the selected channel.

### FIELD OF THE INVENTION

The present invention relates generally to providing improved reception of broadcast signals by electronic devices. In particular, an exemplary embodiment of the present invention provides an alternate channel for a user if a quality metric of the alternate channel is higher than a quality metric of a channel selected by the user.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

It is increasingly common for media content to be available from multiple sources. These sources may include cable and terrestrial broadcast signals among others. For example, a given program may be simultaneously available in both analog and digital formats. Video may be available in a higher resolution format and better quality or multi-channel audio may be available. Often a user is unaware that the same program is available on another channel with better quality video and/or audio. Additionally, the signal on a channel that has been selected by the user may become lost or too degraded for use for many reasons (e.g., bad weather, loss of transmission strength, antenna problems, etc.).

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention; and

FIG. 2 is a process flow diagram representing channel selection based on the determination of a quality metric in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

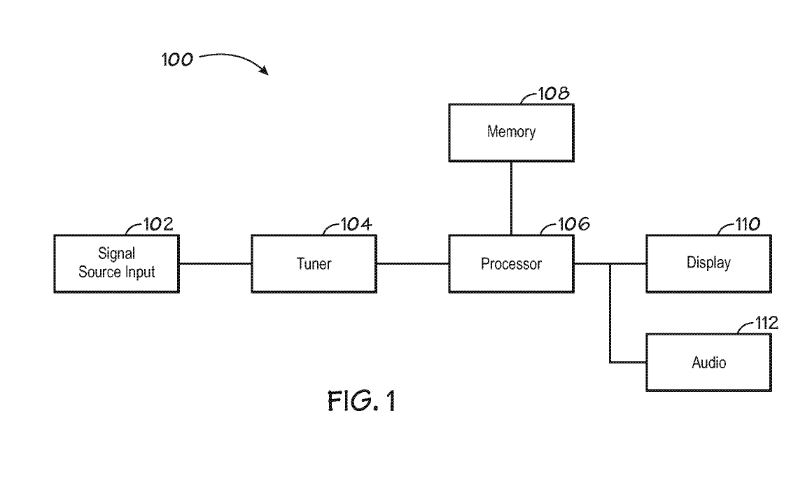

FIG. 1 is a block diagram of an electronic device in accordance with an exemplary embodiment of the present invention. The electronic device is generally referred to by the reference number 100. The electronic device 100 (e.g., a television, a portable DVD player, a DVR, a set-top-box, a VCR, a DVD-Recorder, a satellite receiver, a radio, or the like) comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

A signal source input 102 may comprise an antenna input, an RCA input, an s-video input, a composite video input or the like. Those of ordinary skill in the art will appreciate that, although only one signal source is shown, the electronic device 100 may have multiple signal source inputs. The signal source input 102 is adapted to receive a signal that comprises video data and, in some cases, audio data. The signal received by the signal source input 102 may comprise a broadcast spectrum (e.g., if the signal source input 102 comprises an antenna) or a single channel of video and/or audio data (e.g., if the signal source input 102 comprises a DVD player or the like). A tuner subsystem 104 is adapted to tune a particular program from a broadcast signal received from the signal input source 102.

A processor 106 is adapted to control the overall operation of the electronic device 100. A memory 108 may be associated with the processor 106 to hold machine-readable computer code that causes the processor 106 to control the operation of the electronic device 100 and perform an exemplary method in accordance with the present invention.

A display subsystem 110 may comprise a liquid crystal (LCD) display, a liquid-crystal-on-silicon (LCOS) display, a digital light projection (DLP) display or any other suitable display type. The display subsystem 110 may include a lighting source (not shown) that is used to generate a visible image on the display.

The electronic device 100 may include an audio subsystem 112. The audio subsystem 112, which may comprise an audio amplifier, and audio splitter, etc., may be adapted to play audio data, which may include audio only data or audio data associated with video data being displayed by the electronic device 100.

In an exemplary embodiment of the present invention, the electronic device 100 monitors other channels or data about other channels (e.g., data from an electronic program guide (EPG)) for the purpose of determining if the same program as the program selected by the user is available from an alternate source (i.e., a source other than the source from which the channel selected by the user is being played). Those of ordinary skill in the art would recognize that the alternate source of programming might be delivered via the same delivery method or a secondary delivery method (e.g., two different antenna inputs, a cable input versus an antenna input, etc.). Also, those skilled in the art would recognize that exemplary embodiments of the invention could be applied to audio signals (e.g., AM or FM radio vs. high definition (HD) radio) as well as video signals.

Additionally, the electronic device 100 determines whether the alternate source has a higher quality metric, where the quality metric is based on one or more factors. Those of ordinary skill in the art would recognize that the factors on which the quality metric could be based include the resolution of the signal, the delivery method of the signal, the broadcast format, the signal source, signal noise, signal strength or the like. Information for use in computing the quality metric may be directly measured (e.g., signal strength, data extracted from a signal, etc.) or may be based on previously-stored data about a particular program (e.g., resolution data from an EPG, etc.).

If the electronic device 100 has an EPG available, the processor 106 may execute programming to search for all programs in the EPG program database with a matching program title. Upon finding a matching title, the processor 106 examines the EPG data to determine several program metrics such as whether the program is HDTV, EDTV, or SDTV resolution, or whether the program is analog or digital. This information is then used to determine a quality metric. If there is a resolution data flag within the EPG data indicating the resolution of the program (e.g., 1080i, 720p, 480p, 480i, etc.), then the electronic device 100 can use that information to determine a quality metric based on resolution as well. If a program with a higher quality metric is available, then the electronic device 100 may notify the user, allowing the user to tune to the alternate channel if desired. Alternatively, the electronic device 100 may tune to the alternate channel automatically. Whether the electronic device automatically tunes the alternate channel or notifies the user may be a user-configurable option in a setup menu in an exemplary embodiment of the present invention.

In another exemplary embodiment of the present invention, the processor 106 looks for a matching program on a different channel. If a channel with a matching program is found, the processor 106 may determine a quality metric of the selected channel and the alternate channel based on their respective signal strengths. The signal strength of the alternate channel may be determined using a second tuner if one is available (e.g., the PIP/POP tuner when not in use). The electronic device 100 may then notify the user of the availability of an alternate channel on which the signal strength is better, giving the user the opportunity to tune to the alternate channel. Alternatively, the electronic device 100 may tune to the alternate channel automatically.

In an exemplary embodiment of the present invention, the electronic device 100 may automatically switch reception to an alternate channel with an initial lower quality metric than the selected channel if the reception of the selected channel becomes lost or too degraded to watch. Moreover, the electronic device 100 could change the channel to the alternate channel automatically if the signal strength of the selected channel drops below a specified level. If the quality metric of the alternative channel is not directly measured (e.g., if the quality metric is based on EPG data), the electronic device 100 may inform the user that a better quality program is potentially available on the alternate channel.

In an exemplary embodiment in which the electronic device 100 does not have an EPG, the processor 106 uses a second tuner (e.g., the PIP/POP tuner when not in use) to examine the program titles in the metadata (e.g., Program System Information Protocol (PSIP) data for digital-TV programs or Extended Data Services (XDS) data for analog-TV programs) of other channels. Upon finding a matching title, the processor 106 determines a quality metric for the alternate channel by measuring the resolution on the alternate channel. The processor 106 then determines if the alternate channel has a higher quality metric than the selected channel based on the measured resolution. Alternatively, the processor 106 can examine the channel database to see whether an alternate channel that is playing the same program has a higher quality metric based on whether it is an analog or digital channel. If the alternate channel is in digital format and the user is currently watching the program on an analog channel, the quality metric of the program on the digital channel may be assumed to be higher (i.e., higher resolution). Such information is available because the channel database stores information about whether each channel is analog or digital during an initial channel search when the electronic device 100 is first initialized. If a program with a higher quality metric (i.e., higher resolution) is available, then the electronic device 100 may notify the user, allowing the user to tune to the alternate channel if desired. Alternatively, the electronic device 100 may tune to the alternate channel automatically.

Additionally, in an exemplary embodiment in which the electronic device 100 does not have an EPG or a second tuner, it may be possible to collect the network name and station call letters for each channel from the XDS data during setup and subsequent tuning of channels. This information is stored in the electronic device 100 and used to determine alternate channels that may be broadcasting the same program at a higher quality metric. For example, in the event the user is viewing an analog channel, the corresponding digital channel is either recommended or automatically tuned to based on this information.

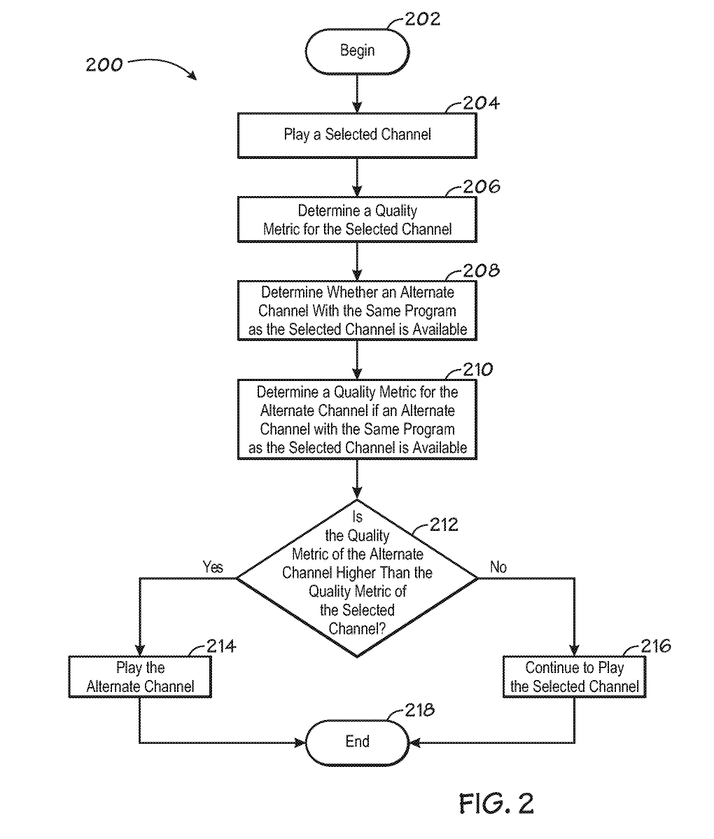

FIG. 2 is a process flow diagram representing channel selection based on the determination of a quality metric in accordance with an exemplary embodiment of the present invention. The channel selection process is generally referred to by the reference number 200. At block 202, the process begins. At block 204, a selected channel is played. At block 206, a quality metric is determined for the selected channel.

At block 208, a determination is made about whether an alternate channel with the same program as the selected channel is available. At block 210, a quality metric is determined for the alternate channel if an alternate channel with the same program as the selected channel is available. At block 212, a determination is made about whether the quality metric is higher for the alternate channel than for the selected channel. If the quality metric is higher for the alternate channel, then the alternate channel is played, as shown at block 214. If the quality metric is not higher for the alternate channel than for the selected channel, then the selected channel continues to be played, as shown at block 216. The process ends in block 218.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method, comprising:
playing a selected channel;
determining a quality metric for the selected channel;
determining whether an alternate channel with the same program as the selected channel is available;
determining a quality metric for the alternate channel if the alternate channel with the same program as the selected channel is available; and
playing the alternate channel if the quality metric of the alternate channel is higher than the quality metric of the selected channel.

2. The method recited in claim 1, comprising:
receiving a request to tune a selected channel; and
tuning a tuner to receive the selected channel.

3. The method recited in claim 1, wherein the alternate channel is played automatically if the quality metric of the second channel is higher than the quality metric of the selected channel.

4. The method recited in claim 1, comprising prompting the user for input on whether to change to the alternate channel.

5. The method recited in claim 1, wherein the quality metric for the selected channel and the quality metric for the alternate channel are determined based on resolution.

6. The method recited in claim 1, wherein the quality metric for the selected channel and the quality metric for the alternate channel are determined based on signal strength.

7. The method recited in claim 1, wherein the quality metric for the selected channel and the quality metric for the alternate channel are determined based on data that is directly measured.

8. The method recited in claim 1, wherein an Electronic Program Guide is used to determine whether the alternate channel is available.

9. An electronic device, comprising:
a display that is adapted to display an image;
an audio system that is adapted to play audio data; and
a processor that is adapted to:
control a tuner to display a selected channel on the display;
determine a quality metric for the selected channel;
determine whether an alternate channel with the same program as the selected channel is available;
determine a quality metric for the alternate channel if the alternate channel with the same program as the selected channel is available; and
display the alternate channel if the quality metric of the alternate channel is higher than the quality metric of the selected channel.

10. The electronic device recited in claim 9, wherein the electronic device comprises a television.

11. The electronic device recited in claim 9, wherein the alternate channel is displayed automatically if the quality metric of the alternate channel is higher than the quality metric of the selected channel.

12. The electronic device recited in claim 9, wherein the processor is adapted to prompt the user for input on whether to change the display to the alternate channel.

13. The electronic device recited in claim 9, wherein the quality metric for the selected channel and the quality metric for the alternate channel are determined based on resolution.

14. The electronic device recited in claim 9, wherein the quality metric for the selected channel and the quality metric for the alternate channel are determined based on signal strength.

15. The electronic device recited in claim 9, wherein the quality metric for the selected channel and the quality metric for the alternate channel are determined based on data that is directly measured.

16. The electronic device recited in claim 9, comprising a second tuner, wherein the processor is adapted to acquire data on which to base the quality metric for the selected channel and the quality metric for the alternate channel from channel data obtained via the second tuner.

17. The electronic device recited in claim 9, wherein metadata of available channels is used to determine the quality metric for the selected channel and the quality metric for the alternate channel.

18. The electronic device recited in claim 9, wherein an Electronic Program Guide is used to determine whether the alternate channel is available.

19. The electronic device recited in claim 18, wherein data from the Electronic Program Guide is used to determine the quality metric for the selected channel and the quality metric for the alternate channel.

20. An electronic device, comprising:
means for playing a selected channel;
means for determining a quality metric for the selected channel;
means for determining whether an alternate channel with the same program as the selected channel is available;
means for determining a quality metric for the alternate channel if the alternate channel with the same program as the selected channel is available; and
means for changing the selected channel to the alternate channel if the quality metric of the alternate channel is higher than the quality metric of the selected channel.
